(19) United States
(12) Patent Application Publication
(10) Pub. No.: US 2024/0088690 A1
(43) Pub. Date: Mar. 14, 2024

(54) METHOD AND SYSTEM FOR CHARGER ADAPTIVE VOLTAGE REGULATION

(71) Applicant: Renesas Electronics America Inc., Milpitas, CA (US)

(72) Inventors: Sungkeun Lim, Apex, NC (US); Chong Han, Cary, NC (US); Yen-Mo Chen, Morrisville, NC (US); HSIEN YI CHOU, Taipei (TW)

(73) Assignee: Renesas Electronics America Inc., Milpitas, CA (US)

(21) Appl. No.: 18/153,417

(22) Filed: Jan. 12, 2023

Related U.S. Application Data
(60) Provisional application No. 63/405,141, filed on Sep. 9, 2022.

(51) Int. Cl. H02J 7/00

(52) U.S. Cl. CPC H02J 7/0068; H02J 7/0049; H02J 7/007182; H02J 2207/20

(57) ABSTRACT

Systems and methods for adaptive voltage regulation are described. According to an example, a method for operating a charger may include setting, by a charger controller of the charger, a maximum regulation voltage threshold and a minimum regulation voltage threshold, the minimum regulation voltage threshold being a predetermined percentage of the maximum regulation voltage threshold, the predetermined percentage ranging from between about 90% and about 98%; setting, by the charger controller, a charger regulation voltage to the maximum regulation voltage threshold; determining, by a battery monitor, a state of charge of a battery module; and operating the charger at the maximum regulation voltage threshold until the battery module is maximally charged.

### CROSS-REFERENCE TO RELATED APPLICATION

The present application claims the benefit of U.S. Patent Application No. 63/405,141, titled “Adaptive VSYS Regulation Scheme Preventing Floating Charging and Acoustic Noise for Battery Charger Products” and filed on Sep. 9, 2022, which is hereby incorporated by reference in its entirety.

### BACKGROUND

Unless otherwise indicated herein, the materials described in this section are not prior art to the claims in this application and are not admitted to be prior art by inclusion in this section. The present disclosure relates in general to systems and methods of controlling semiconductor devices, more particularly, to control of a battery charger or a power converter.

A charger (e.g., a battery charger) may operate in different modes depending on the amount of power available in view of an instantaneous load. For example, a charger may operate in a first mode, where a power adapter (e.g., a power source) may apply power to a charger so that power from the power adapter may be provided through the charger to a load attached to the charger, and where the charger is working as a power converter to provide power from the power adapter to the load. In this case, power from the power adapter may also be applied to charge one or more rechargeable batteries attached to the charger in a charger forward mode. The charger may operate in a second mode where the charger may be disconnected from the power adapter, or the power adapter may be shut off, and the load (e.g., a power or current demand) may be supplied by the charged batteries through the charger in a reverse mode, where the charger is working as a power converter to provide power from the batteries to the load. Finally, the charger may operate in a third mode where the power adapter may apply power to the charger so that power from the power adapter may be provided through the charger to the load attached to the charger, and supplemental power may be provided by the one or more charged batteries attached to the charger, so that the full power demand of the load may be satisfied when that demand is higher than may be satisfied by the power adapter through the charger alone.

As used herein, the phrase forward mode refers to the direction of power flow into the batteries (e.g., batteries charging), and the phrase reverse mode refers to the direction of power flow out from the batteries (e.g., batteries discharging). In some cases, a mode timer may be used to activate the charger in a particular mode for a particular duration of time. For example, the charger may enter the supplemental mode once the excess power requirement from the load is detected and may remain in the supplemental mode until the timer expires by reaching the end of a predetermined time interval.

Based on the above example, if the load slightly exceeds the rated capacity of the charger, the amount of power drawn by the load (e.g., the amount of current drawn by the load) may be higher than a threshold amount to activate the supplemental mode. Alternatively, after activation of the supplemental mode the load may transition from powering a load that is slightly above the rated capacity of the charger, where supplemental power from the batteries is needed, to powering the load at a level that is slightly within (e.g., slightly below) the rated capacity of the charger, where supplemental power from the batteries is not needed. Hence, after activating the supplemental mode and while the mode timer is running, a charger controller may determine that supplemental mode power is no longer needed, and then discontinue the supplemental mode after the timer expires. After the load transitions to below the rated capacity of the charger, the charger may begin to charge the batteries during the remainder of the timer period. In this case, the batteries may already be fully charged. This may cause the charger to cycle between activating and deactivating the supplemental mode, between charging and discharging the fully charged batteries, based on the current demand and the timer.

Charging already fully charged batteries may reduce the battery capacity, shorten the useful lifetime of the batteries, or may lead to other problems. Further, the repeated charging and discharging of the batteries may lead to the generation of acoustic noise based on the repeated, sharp application of power to various components, such as capacitors and inductors, generating sound that may be undesirable to a user or bystander. What is needed is a solution that addresses these problems, and others.

### SUMMARY

According to one example, a semiconductor device is generally described. The semiconductor device may include a charger that includes a charger controller and a power stage, the power stage having a power stage first side and a power stage second side, the power stage first side configured to receive electrical power from a power adapter, the power stage second side configured to provide electrical power to a load, the power stage second side configured to connect to a battery module including one or more rechargeable battery cells, the battery module configured to receive electrical power from the power stage second side to charge the battery module at a regulation voltage, the battery module configured to provide supplemental power to the load based on the charger controller; and a battery monitor connected to the charger controller and the battery module, the battery monitor configured to determine a battery module state of charge, the state of charge including one of maximally charged, at least minimally charged, and less than minimally charged, wherein the charger controller is configured to set the regulation voltage based on an amount of power received from the power adapter and the state of charge, and wherein the charger controller is configured to set the regulation voltage to a maximum regulation voltage threshold until the battery module is maximally charged.

According to this example, the semiconductor device wherein the charger controller sets the regulation voltage to a minimum regulation voltage threshold when the battery module is maximally charged, the minimum regulation voltage threshold being a predetermined percentage of the maximum regulation voltage threshold, the predetermined percentage ranging from between about 90% and about 98%. The semiconductor device wherein the charger controller sets the regulation voltage to the maximum regulation voltage threshold when the battery module is less than minimally charged. The semiconductor device further including a switch element to connect the battery module with the power stage second side, the charger controller configured to enable the switch element to provide supplemental power from the battery module to the load in a charger reverse mode, the charger controller configured to disable the switch element to charge the battery module at the regulation voltage in a charger forward mode. The semiconductor device wherein the charger controller includes a pulse width modulator control module configured to control at least one pulse width modulator signal configured to drive the power stage when enabled. The semiconductor device wherein the power stage includes a buck-boost power stage, and wherein the charger includes a buck-boost charger.

According to another example, a semiconductor system is generally described. A semiconductor system may include a charger including a charger controller and a power stage, the power stage having a power stage first side and a power stage second side, the power stage first side configured to receive electrical power from a power adapter, the power stage second side configured to provide electrical power to a load; a battery module including one or more rechargeable battery cells connected to the power stage second side, the battery module configured to receive electrical power from the power stage second side to charge the battery module at a regulation voltage, the battery module configured to provide supplemental power to the load based on the charger controller; and a battery monitor connected to the charger controller and the battery module, the battery monitor configured to determine a state of charge of the battery module, the state of charge including one of maximally charged, at least minimally charged, and less than minimally charged, wherein the charger controller is configured to set the regulation voltage based on an amount of power received from the power adapter and the state of charge, and wherein the charger controller is configured to set the regulation voltage to a maximum regulation voltage threshold until the battery module is maximally charged.

According to this example, the semiconductor system wherein the charger controller sets the regulation voltage to a minimum regulation voltage threshold when the battery module is maximally charged, the minimum regulation voltage threshold being a predetermined percentage of the maximum regulation voltage threshold, the predetermined percentage ranging from between about 90% and about 98%. The semiconductor system wherein the charger controller sets the regulation voltage to the maximum regulation voltage threshold when the battery module is minimally charged. The semiconductor system wherein the one or more batteries of the battery module including at least one of Li-Ion, NiMH, and NiCd batteries arranged in one of a series configuration, a parallel configuration, or a series-parallel configuration. The semiconductor system wherein the charger controller further includes a loop control module configured to set the regulation voltage and a pulse width modulator control module configured to control at least one pulse width modulator signal connected to the power stage and configured to drive the power stage when enabled. The semiconductor system wherein the power stage includes a buck-boost power stage, and wherein the charger includes a buck-boost charger. The semiconductor system further including a switch element to connect the battery module with the power stage second side, the charger controller configured to enable the switch element to provide supplemental power from the battery module to the load in a charger reverse mode, the charger controller configured to disable the switch element to charge the battery module at the regulation voltage in a charger forward mode. The semiconductor system wherein the charger controller setting the regulation voltage to a minimum regulation voltage threshold when the battery module is maximally charged at least one of reduces acoustic noise from the charger and reduces float charging the battery module.

According to yet another example, a method for operating a charger may include setting, by a charger controller of the charger, a maximum regulation voltage threshold and a minimum regulation voltage threshold, the minimum regulation voltage threshold being a predetermined percentage of the maximum regulation voltage threshold, the predetermined percentage ranging from between about 90% and about 98%; setting, by the charger controller, a charger regulation voltage to the maximum regulation voltage threshold; determining, by a battery monitor, a state of charge of a battery module; and operating the charger at the maximum regulation voltage threshold until the battery module is maximally charged.

According to this example, the method wherein operating the charger at the maximum regulation voltage threshold further includes charging, by the charger controller, the battery module at the maximum regulation voltage threshold; and operating the charger as a power converter while maximally charging the battery module. The method further includes setting, by the charger controller, the charger regulation voltage to the minimum regulation voltage threshold when the battery module is maximally charged. The method further includes determining, by the battery monitor, the state of charge (SOC) of the battery module; and operating the charger at the minimum regulation voltage threshold when the battery module is at least minimally charged. The method wherein operating the charger at the minimum regulation voltage threshold further includes charging, by the charger, the battery module at the minimum regulation voltage threshold; and operating the charger as a power converter while minimally charging the battery module. The method further includes setting, by the charger controller, the charger regulation voltage to the maximum regulation voltage threshold when the battery module is not at least minimally charged.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 illustrates an example of an electronic system that can implement adaptive system voltage regulation for a charger in accordance with various examples of the present disclosure.

FIG. 2 illustrates an example of a loop control module for a charger controller, in accordance with various examples of the present disclosure.

FIG. 3 illustrates a battery monitor state of charge (SOC), in accordance with various examples of the present disclosure.

FIG. 4 is a flow diagram illustrating a method for operating a charger, in accordance with various examples.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

To be described in more detail below, charger adaptive voltage regulation can be implemented by a system and method described in accordance with the present disclosure. The system can provide adaptive voltage regulation for a charger in a solution that can be relatively compact, allowing the adaptive voltage regulation technique described herein to fit in applications with limited size, weight, and cost. The described solution recognizes the disruptions that may be caused by charging an already fully-charged battery and disruptions caused by increased acoustic noise conditions in some applications. Thus, the described solution addresses these and other issues. Moreover, the system and method can provide an efficient voltage regulation technique for use with various consumer electronic devices.

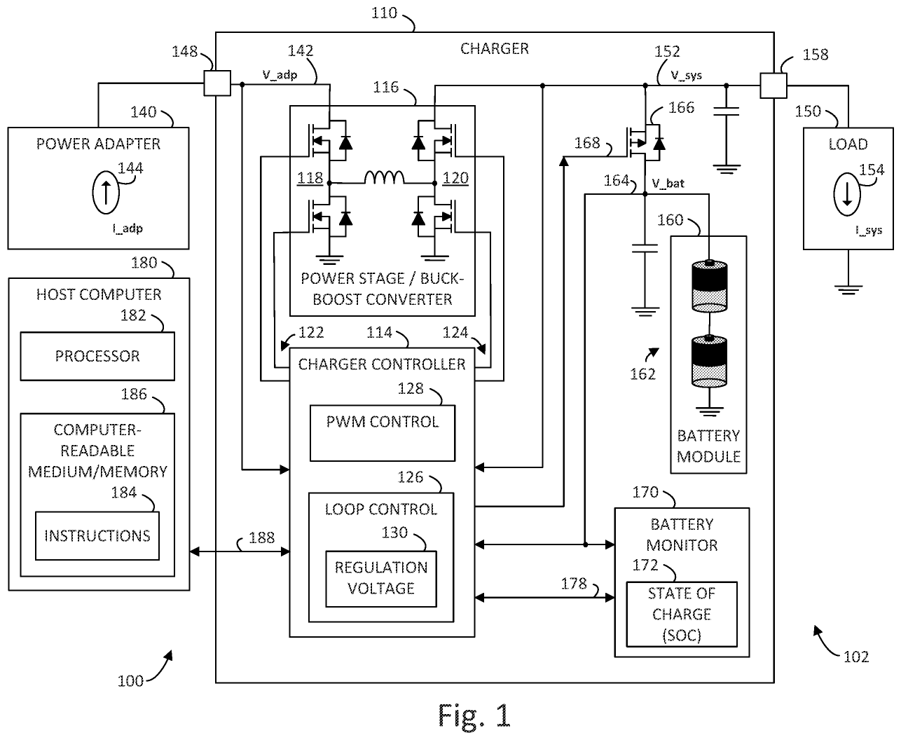

FIG. 1 illustrates an example of an electronic system that can implement an adaptive voltage regulation solution in accordance with various examples of the present disclosure. Electronic system 100 may include two or more electronic devices or components. Electronic system 100 may be implemented generally as a semiconductor system 100 that may include an electronic device 102 which may be implemented generally as a semiconductor device 102 along with one or more semiconductor circuits, semiconductor chips, memory elements, discrete components, and the like.

According to an example, semiconductor device 102 may include a charger 110 that also includes a charger controller 114 and a power stage 116 with a power stage first side 118 and a power stage second side 120. Power stage first side 118 may be configured to receive electrical power from a power adapter 140 at an adapter voltage 142 (V_adp) and at an adapter current 144 (I_adp). Power adapter 140 may connect to power stage first side 118 through a releasable electrical connector 148 (e.g., a plug) of a suitable type. Power stage second side 120 may be configured to provide electrical power from power adapter 140 through power stage 116 to a load 150 at a system voltage 152 (V_sys) and at a system current 154 (I_sys) based on charger controller signals 122 applied to power stage first side 118 and charger controller signals 124 applied to power stage second side 120. Power stage second side 120 may connect to load 150 through a releasable electrical connector 158 of a suitable type. Power stage second side 120 may be configured to connect to a battery module 160 comprising one or more rechargeable battery cells 162. As illustrated, power stage 116 may be implemented as a buck-boost power stage (e.g., buck-boost converter) so that charger 110 comprises a buck-boost charger. An advantage of utilizing a buck-boost power stage includes the ability to provide an output voltage that is higher than an input voltage. Alternatively, power stage 116 may be implemented as a buck power stage having switching devices corresponding to power stage second side 120, so that charger 110 may be a buck charger. Advantages of utilizing a buck power stage include lower cost and complexity compared with utilizing a buck-boost power stage.

Charger controller 114 may include a loop control module 126 configured to determine an operational mode of charger 110. Charger controller 114 may also include a pulse width modulator control module 128 having a plurality of pulse width modulators (PWMs) to control power flow through power stage 116, charging and discharging of battery module 160, and applying supplemental power from battery module 160 to load 150 by varying the on/off characteristics of control signals. In particular, a separate pulse width modulator signal (e.g., output) may be connected to each of charger controller signals 122 applied to control elements (e.g., the power transistors) of power stage first side 118 and charger controller signals 124 applied to control elements of power stage second side 120. Charger controller 114 may also include a regulation voltage module 130 to set the output voltage 152 (V_sys) as a regulator output.

Battery module 160 may be configured to receive electrical power from power stage second side 120 to charge the one or more rechargeable battery cells 162 in battery module 160 at a charger regulation voltage 130. Battery module 160 may be configured to provide supplemental power to load 150 based on charger controller 114. In this manner, charger controller 114 may drive power stage 116 to provide power from power adapter 140 along with supplemental power from battery module 160 to load 150. As used herein, the phrase forward mode refers to the direction of power flow into batteries 162 (e.g., batteries charging), and the phrase reverse mode refers to the direction of power flow out from batteries 162 (e.g., batteries discharging).

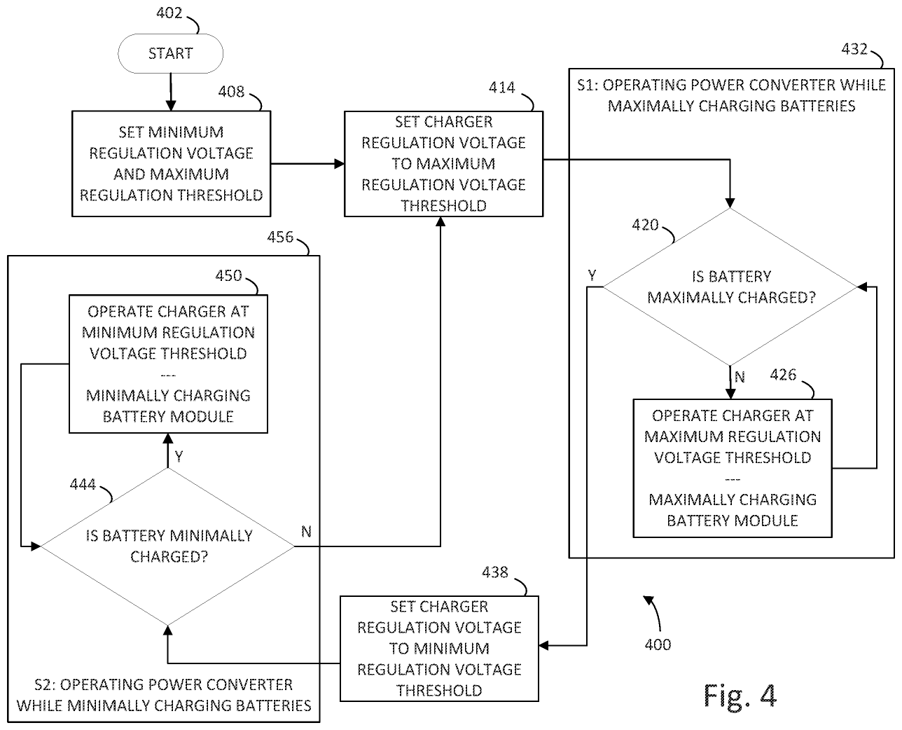

A battery monitor 170 may be connected to charger controller 114 and battery module 160. Battery monitor 170 may be configured to determine a battery module state of charge 172 (SOC). As will be described more fully below, state of charge 172 of battery module 160 may be one of maximally charged (e.g., fully-charged), at least minimally charged (e.g., at or above a minimum charge level), and less than minimally charged (e.g., lower than the minimum charge level). Battery module 160 may have a battery voltage 164 (V_bat) that is applied to charger controller 114 and battery monitor 170. In this manner, battery monitor 170 may measure various aspects of the one or more rechargeable batteries to compute state of charge 172 of battery module 160, including measure battery voltage, current measurement, current integration, temperature measurement, to function as a “fuel gauge” for battery module 160. Charger controller 114 may be configured to set regulation voltage 130 based on an amount of power received from power adapter 140, power stored in battery module 160 based on state of charge 172, and amount of power drawn by load 150. A control and status signal 178 may be asserted between battery monitor 170 charger controller 114 to provide configuration control for battery monitor 170 based on threshold values 220 mentioned above, and to provide status regarding state of charge 172 so that loop control module 126 may determine an operational mode (e.g., state S1 or state S2 and transitions therebetween of FIG. 4) of charger 110.

Connected between battery module 160 and power stage second side 126 may be a semiconductor switch element 166 configured to selectively connect the output of battery module 160 (V_bat) to power stage second side 120 to provide supplemental power from battery module 160 to load 150 when switch signal 168 from charger controller 114 is enabled. Switch signal 168 may be generated by pulse width modulator control module 128 so the amount of supplemental power from battery module 160 is carefully controlled. Conversely, battery module 160 may be charged from power stage second side 120 when switch signal 168 is disabled. In this manner, charger controller 114 may be configured to enable switch element 166 to provide supplemental power from battery module 160 to load 150 in a charger reverse mode. Conversely, charger controller 114 may be configured to disable switch element 166 to charge battery module 160 at regulation voltage 130 in a charger forward mode. Semiconductor switch element 166 may be an n-type metal oxide semiconductor field effect transistor (n-MOSFET), or other suitable component.

A host computer 180 may interface with charger 110 to both provide instructions and configuration information to charger 110, and to receive status information from charger 110 regarding system performance, possible faults, and other information. Host computer 180 may include a processor 182, such as a microprocessor configured to read program instructions 184 (e.g., computer implemented code) from a non-transitory computer-readable medium 186 such as a read-only memory (ROM), a random access memory (RAM), a programmable logic device (PLD), a flash drive, a memory card/stick, a solid-state storage device, or the like. Program instructions 184, read from computer-readable medium 186 by processor 182 and/or specialized controller as a processor device, may cause processor 182 to provide configuration settings and information to charger 110 to execute operations corresponding to the functions, processes, and methods described herein, as will be discussed more fully below. Computer-readable medium 186 may be removable, replaceable, or re-writeable so that program instructions 184 in computer-readable medium 186 may be modified, upgraded, or replaced.

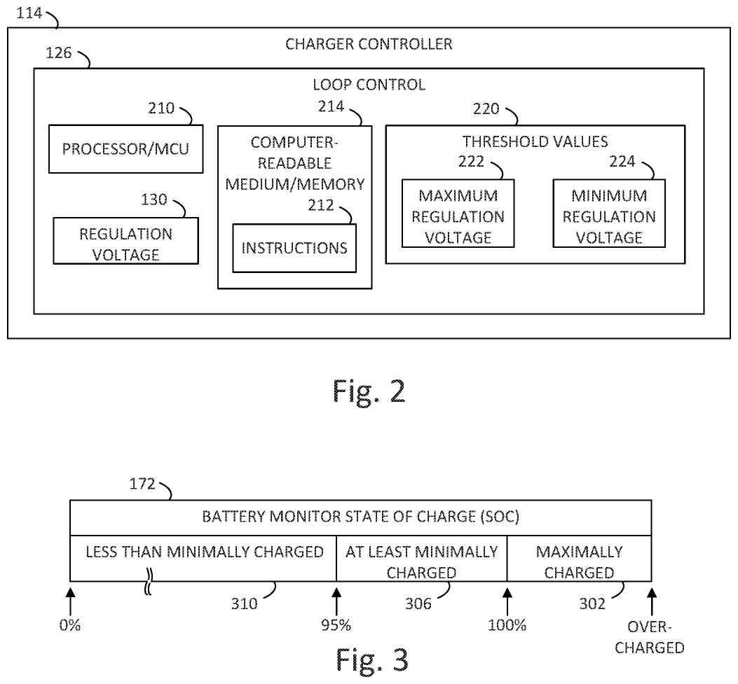

FIG. 2 illustrates an example of loop control module 126 for charger controller 114 (and more broadly for charger 110), in accordance with various examples of the present disclosure. According to an example, loop control module 126 may include various threshold values 220, including a maximum regulation voltage threshold 222 and a minimum regulation voltage threshold 224. These values may be stored in charger regulation voltage module 130 to determine the system voltage output to a load 150, as described briefly in reference to FIG. 1. Loop control module 126 may include a processor 210, such as a microprocessor or microcontroller (MCU) configured to read program instructions 212 (e.g., computer implemented code) from a non-transitory computer-readable medium 214 such as a read-only memory (ROM), a random access memory (RAM), a programmable logic device (PLD), a flash drive, a memory card/stick, a solid-state storage device, or the like. Program instructions 212, read from computer-readable medium 214 by processor 210 and/or specialized controller as a processor device, may cause processor 210 to execute operations corresponding to the functions, processes, and methods described herein. Computer-readable medium 214 may be removable, replaceable, or re-writeable so that program instructions 212 in computer-readable medium 214 may be modified, upgraded, or replaced. Loop control module 126 may also include various Arithmetic and Logical Units (ALUs) to perform calculation and comparison operations described herein. Charger controller 114 (and more broadly charger 110) may receive control signals and provide status signals host computer 180 through control and status interface 188.

With reference to both FIG. 1 and FIG. 2, charger controller 114 may initially be configured to set regulation voltage 130 to maximum regulation voltage threshold 222 until battery module 160 is maximally charged. After this, charger controller 114 may set the regulation voltage to minimum regulation voltage threshold 224 when battery module 160 is maximally charged. By lowering the system output voltage to load 150 once battery module 160 is fully charged, or nearly fully charged, the system may avoid “float charging” the one or more batteries 162 in battery module 160 during a remaining portion of a supplemental supply of power to load 150 when a demand level changes from slightly above capacity to slightly below capacity of charger 110 alone, and the system may avoid repeated activation of the charging and discharging of battery module 160. Each sharp activation of the charging and discharging of battery module 160 may cause a physical stress to various components, such as ceramic capacitors attached to a printed circuit board, so that the physical stress may cause acoustic noise to be emitted based on these physical changes. By reducing the frequency of activation of the charging and discharging cycle, or by limiting the activation of charging and discharging when battery module 170 is fully-charged or nearly fully-charged, the amount of acoustic noise generated by this activation may also be reduced. Stated differently, charger controller 114 setting regulation voltage 130 to minimum regulation voltage threshold 224 when battery module 160 is maximally charged may reduce acoustic noise from the charger and/or reduce float charging battery module 160. In this manner, charger 110 voltage regulation may be adapted to state of charge 172 of battery module 160.

As discussed herein, maximum regulation voltage threshold 222 and minimum regulation voltage threshold 224 may be assigned to regulation voltage 130 and may correspond to system voltage 152 (V_sys) output to load 150. Stated differently, regulation voltage 130 may correspond to a regulator voltage output, or an output voltage level needed from charger 110 when acting as a power converter or a power regulator and applying power to load 150 (e.g., when driving load 150). For example, when battery module 170 includes three battery cells arranged in series, and maximum regulation voltage threshold 222 is set to 12.576 Volts, then minimum regulation voltage threshold 224 may be set to 11.947 Volts (e.g., lower by about −629 mV) which is about 95% of maximum regulation voltage threshold 222 as a predetermined percentage of maximum regulation voltage threshold 222. Other predetermined percentage values for minimum regulation voltage threshold 224 may range, for example, between about −400 mV to about −600 mV of maximum regulation voltage threshold 222, or from about 90% to about 98% of maximum regulation voltage 222, inclusive, and may preferably be about 95%. As used herein, the term about is a relative term intended to allow for variations in component values, component settings, and system performance over time and may include up to 1% variance so that predetermined minimum regulation voltage threshold 224 set to 95% may be as low as 94% and as high as 96%. Similarly, predetermined minimum regulation voltage threshold 224 being set to any value between about 90% to 98%, and may be as low as 89% and a high as 99%. Following this, charger controller 114 may set regulation voltage 130 to maximum regulation voltage threshold 222 when the battery module is less than minimally charged. Other thresholds, and other relationships between the thresholds, may be selected based on the performance of a particular system in a particular situation.

FIG. 3 illustrates battery monitor state of charge 172 (SOC), in accordance with various examples of the present disclosure. Battery module 160 may be implemented as one or more batteries 162 of various technologies, including nickel-metal hydride (NiMH), Nickel-Cadmium (NiCd), or Lithium Ion (Li-ion) battery of various voltage and current capacities. Battery module 160 may including two or more batteries connected and arranged serially, arranged in parallel, or arranged in a series-parallel configuration, or the like.

State of charge 172 of battery module 160 may be one of maximally charged 302 (e.g., fully-charged), at least minimally charged 306 (e.g., at or above a minimum charge level), and less than minimally charged 310 (e.g., lower than the minimum charge level). Maximally charged 302 corresponds to a region where battery module 160 is fully charged based on an expected demand profile of load 150 and based on ratings of the one or more battery cells 162 and how they are arranged in battery module 160. Battery voltage 164 may be used alone or in combination with other measurements to reflect state of charge 172, where battery voltage 164 may be compared with predetermined minimum regulation voltage threshold 224 to determine a transition point between less than minimally charged 310 and at least minimally charged 306. The arrangement of battery cells 162 may be communicated to charger controller 114 using pin settings, writing configuration information to a register within processor 210 or associated control logic, or writing configuration information to a location in memory 214, or the like. As used herein, the terms set, sets, or setting may refer to any of these actions.

FIG. 4 is a flow diagram illustrating a method for operating a charger, in accordance with various examples. Method 400 (e.g., process 400) may be implemented on hardware such as electronic system 100 or electronic device 102 described in reference to FIG. 1 to FIG. 3. An example process may include one or more operations, actions, or functions as illustrated by one or more of blocks 402-456, as illustrated in FIG. 4. Although illustrated as discrete blocks, various blocks may be divided into additional blocks, combined into fewer blocks, eliminated, performed in a different order, or performed in parallel, when not prohibited, depending on the desired implementation.

With reference to FIG. 1 to FIG. 4, method 400 begins in step 402 and proceeds in step 408 with setting maximum regulation voltage threshold 222 and minimum regulation voltage threshold 224. Method 400 proceeds in step 414 with setting charger regulation voltage 130 to maximum regulation voltage threshold 222. Method 400 proceeds in step 420 with determining, by a battery monitor 170, a state of charge 172 of a battery module 160, and in step 426 proceeds with operating charger 110 at maximum regulation voltage threshold 222 until battery module 160 is maximally (e.g., fully) charged. While battery module is not fully charged, method 400 remains in step 432 by operating charger 110 as a power converter while maximally charging battery module 160 corresponding to a state S1. In this manner, the process requires battery module 160 be maximally (e.g., fully) charged prior to implementing the adaptive voltage regulation described herein.

Once battery module 160 is fully charged, method 400 proceeds in step 438 with setting, by charger controller 114, charger regulation voltage 130 to minimum regulation voltage threshold 224. Method 400 proceeds in step 444 with determining, by battery monitor 170, state of charge 172 (SOC) of battery module 160, and in step 450 proceeds with operating charger 110 at minimum regulation voltage threshold 130 when battery module 160 is at least minimally charged. In method step 450, operating charger 110 at minimum regulation voltage threshold 222 further includes charging, by charger 110, battery module 160 at minimum regulation voltage threshold 224, and in step 456 the method includes operating charger 110 as a power converter while minimally charging the battery module, corresponding to a state S2. While operating in state S2, if battery module 160 state of charge 172 falls below a level corresponding to at least minimally charged 306 and into a level corresponding to less than minimally charged 310, method 400 proceeds (again) in step 414 with setting, by charger controller 114, charger regulation voltage 130 to maximum regulation voltage threshold 222. In this manner, the process of method 400 is intended to continue.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The various embodiments were chosen and described in order to best explain the principles of the invention and the practical application, and to enable others of ordinary skill in the art to understand the invention for various embodiments with various modifications as are suited to the particular use contemplated.

What is claimed is:

1. A semiconductor device, comprising:
a charger comprising a charger controller and a power stage, the power stage having a power stage first side and a power stage second side, the power stage first side configured to receive electrical power from a power adapter, the power stage second side configured to provide electrical power to a load, the power stage second side configured to connect to a battery module comprising one or more rechargeable battery cells, the battery module configured to receive electrical power from the power stage second side to charge the battery module at a regulation voltage, the battery module configured to provide supplemental power to the load based on the charger controller; and
a battery monitor connected to the charger controller and the battery module, the battery monitor configured to determine a battery module state of charge, the state of charge comprising one of maximally charged, at least minimally charged, and less than minimally charged,
wherein the charger controller is configured to set the regulation voltage based on an amount of power received from the power adapter and the state of charge, and
wherein the charger controller is configured to set the regulation voltage to a maximum regulation voltage threshold until the battery module is maximally charged.

2. The semiconductor device of claim 1, wherein the charger controller sets the regulation voltage to a minimum regulation voltage threshold when the battery module is maximally charged, the minimum regulation voltage threshold being a predetermined percentage of the maximum regulation voltage threshold, the predetermined percentage ranging from between about 90% and about 98%.

3. The semiconductor device of claim 2, wherein the charger controller sets the regulation voltage to the maximum regulation voltage threshold when the battery module is less than minimally charged.

4. The semiconductor device of claim 1, further comprising a switch element to connect the battery module with the power stage second side, the charger controller configured to enable the switch element to provide supplemental power from the battery module to the load in a charger reverse mode, the charger controller configured to disable the switch element to charge the battery module at the regulation voltage in a charger forward mode.

5. The semiconductor device of claim 1, wherein the charger controller includes a pulse width modulator control module configured to control at least one pulse width modulator signal configured to drive the power stage when enabled.

6. The semiconductor device of claim 1, wherein the power stage comprises a buck-boost power stage, and wherein the charger comprises a buck-boost charger.

7. A semiconductor system, comprising:
a charger comprising a charger controller and a power stage, the power stage having a power stage first side and a power stage second side, the power stage first side configured to receive electrical power from a power adapter, the power stage second side configured to provide electrical power to a load;
a battery module comprising one or more rechargeable battery cells connected to the power stage second side, the battery module configured to receive electrical power from the power stage second side to charge the battery module at a regulation voltage, the battery module configured to provide supplemental power to the load based on the charger controller; and
a battery monitor connected to the charger controller and the battery module, the battery monitor configured to determine a state of charge of the battery module, the state of charge comprising one of maximally charged, at least minimally charged, and less than minimally charged,
wherein the charger controller is configured to set the regulation voltage based on an amount of power received from the power adapter and the state of charge, and
wherein the charger controller is configured to set the regulation voltage to a maximum regulation voltage threshold until the battery module is maximally charged.

8. The semiconductor system of claim 7, wherein the charger controller sets the regulation voltage to a minimum regulation voltage threshold when the battery module is maximally charged, the minimum regulation voltage threshold being a predetermined percentage of the maximum regulation voltage threshold, the predetermined percentage ranging from between about 90% and about 98%.

9. The semiconductor system of claim 7, wherein the charger controller sets the regulation voltage to the maximum regulation voltage threshold when the battery module is minimally charged.

10. The semiconductor system of claim 7, wherein the one or more batteries of the battery module comprising at least one of Li-Ion, NiMH, and NiCd batteries arranged in one of a series configuration, a parallel configuration, or a series-parallel configuration.

11. The semiconductor system of claim 7, wherein the charger controller further comprises a loop control module configured to set the regulation voltage and a pulse width modulator control module configured to control at least one pulse width modulator signal connected to the power stage and configured to drive the power stage when enabled.

12. The semiconductor system of claim 7, wherein the power stage comprises a buck-boost power stage, and wherein the charger comprises a buck-boost charger.

13. The semiconductor system of claim 7, further comprising a switch element to connect the battery module with the power stage second side, the charger controller configured to enable the switch element to provide supplemental power from the battery module to the load in a charger reverse mode, the charger controller configured to disable the switch element to charge the battery module at the regulation voltage in a charger forward mode.

14. The semiconductor system of claim 7, wherein the charger controller setting the regulation voltage to a minimum regulation voltage threshold when the battery module is maximally charged at least one of reduces acoustic noise from the charger and reduces float charging the battery module.

15. A method for operating a charger, the method comprising:
setting, by a charger controller of the charger, a maximum regulation voltage threshold and a minimum regulation voltage threshold, the minimum regulation voltage threshold being a predetermined percentage of the maximum regulation voltage threshold, the predetermined percentage ranging from between about 90% and about 98%;
setting, by the charger controller, a charger regulation voltage to the maximum regulation voltage threshold;
determining, by a battery monitor, a state of charge of a battery module; and
operating the charger at the maximum regulation voltage threshold until the battery module is maximally charged.

16. The method of claim 15, wherein operating the charger at the maximum regulation voltage threshold further comprises:
charging, by the charger controller, the battery module at the maximum regulation voltage threshold; and
operating the charger as a power converter while maximally charging the battery module.

17. The method of claim 15, further comprising:
setting, by the charger controller, the charger regulation voltage to the minimum regulation voltage threshold when the battery module is maximally charged.

18. The method of claim 17, further comprising:
determining, by the battery monitor, the state of charge (SOC) of the battery module; and
operating the charger at the minimum regulation voltage threshold when the battery module is at least minimally charged.

19. The method of claim 18, wherein operating the charger at the minimum regulation voltage threshold further comprises:
charging, by the charger, the battery module at the minimum regulation voltage threshold; and
operating the charger as a power converter while minimally charging the battery module.

20. The method of claim 19, further comprising:
setting, by the charger controller, the charger regulation voltage to the maximum regulation voltage threshold when the battery module is not at least minimally charged.
